(19) United States
(12) Patent Application Publication
(10) Pub. No.: US 2009/0321229 A1
(43) Pub. Date: Dec. 31, 2009

(54) "TURN-SIGNAL SWITCH FOR A MOTOR VEHICLE WHICH HAS AN ADAPTIVE CRUISE CONTROL"

(76) Inventor: Karsten Haug, Stuttgart (DE)

Correspondence Address: KENYON & KENYON LLP, ONE BROADWAY, NEW YORK, NY, 10004, US

(21) Appl. No.: 11/988,674

(22) PCT Filed: May 30, 2006
(86) PCT No.: PCT/EP2006/062687

§ 371 Date: Apr. 27, 2009

(30) Foreign Application Priority Data
Jul. 14, 2005 (DE) 10 2005 032 847.4

(51) Int. Cl. H01H 3/16

(52) U.S. Cl. 200/61.27

(57) ABSTRACT

A turn-signal switch for a motor vehicle, which has an adaptive cruise control, has, in addition to an OFF position and an ON position, at least one command position situated beyond the ON position, in which it outputs a command to the cruise control to modify the setpoint acceleration.

### BACKGROUND INFORMATION

Adaptive cruise controls, also referred to as ACC systems, are used in motor vehicles for the purpose of automatically regulating the velocity to a desired velocity selected by the driver if the roadway is free, or, if a vehicle traveling ahead more slowly is located in the same lane, for adapting the velocity automatically to the vehicle traveling ahead. For this purpose, the position of the vehicle traveling ahead is found with the aid of a radar sensor, for example. The cruise control calculates a suitable positive or negative setpoint acceleration on the basis of the distance and relative velocity data measured with the aid of the radar sensor, to adapt its own velocity comfortably to that of the vehicle traveling ahead or, if the vehicle traveling ahead has left the same lane, to accelerate again to the desired velocity. This calculated setpoint acceleration is implemented by a corresponding intervention in the drive system and/or braking system of the vehicle, so that the driver normally does not need to operate the gas pedal when traveling on a freeway, for example.

However, when the driver decides to pass the slower vehicle which has been followed until now, a temporary acceleration of his own vehicle is generally necessary so that threading into the traffic in the passing lane is made easier. For this purpose, the driver may temporarily override the cruise control by operating the gas pedal.

A cruise control is described in German Patent No. DE 101 14 187, in which, when the driver intends to change lanes, the sensitivity range of the radar sensor is temporarily expanded to the affected neighboring lane, so that the velocities of the vehicles traveling in this neighboring lane are included in the analysis and the acceleration or deceleration behavior may thus be adapted automatically to the traffic in the neighboring lane. The driving comfort is increased further in this way, but it often proves to be difficult to adapt the acceleration or deceleration behavior correctly to the particular traffic situation, because there is usually no rearward-facing radar in typical ACC systems, and therefore vehicles which approach rapidly from the rear in the passing lane may not be taken into consideration appropriately in the automatic regulation.

The driver's intention to change lanes is recognized in the known system in that the driver operates the direction-indicator lamp (turn signal) before the lane change. In this context, providing a special switch in combination with the turn-signal switch, using which the driver may signal to the cruise control a wish to pass without the turn signal already being operated, has also already been suggested.

The turn-signal switch of a motor vehicle typically has an OFF position and two ON positions, in which either the left or the right turn signal is turned on. Each ON position is frequently subdivided further into a touch stage for brief signaling and a switched stage, in which the turn-signal switch engages, so that the affected turn-signal remains turned on until the steering wheel is returned to the neutral position after a significant steering angle was reached, by which the turn-signal switch is automatically released again. The driver feels a certain pressure point between the touch stage and the switched stage.

If a switching function, using which the driver may signal to the cruise control his wish to pass before the turn signal is activated, is additionally to be implemented, the corresponding switched stage must expediently lie between the OFF position and the touch stage of the ON position. To make the various positions sufficiently clearly differentiable, a second pressure point must be provided, which, however, may easily result in faulty operation and/or is perceived as annoying during the normal operation of the turn signal to indicate an intention of making a turn.

### SUMMARY OF THE INVENTION

The present invention offers the driver the advantageous possibility of inputting a manual acceleration or deceleration command in the event of an intended lane change with the aid of the turn-signal switch. Since the driver must operate the turn-signal switch before a lane change, in any case this approach proves to be outstandingly comfortable and ergonomic.

Since the command position for the manual input of the acceleration or deceleration command on the turn-signal switch lies beyond the ON position, the normal function of the turn-signal switch is not disturbed when setting the direction-indicator lamp. The vehicle is caused to accelerate or decelerate only when the driver moves the turn-signal switch beyond the ON position. The driver may also manually control the duration of this acceleration or deceleration phase with the aid of the turn-signal switch and thus adapt the acceleration or deceleration behavior optimally to the particular traffic situation without having to operate the gas pedal or the brake pedal using his foot.

The turn-signal switch preferably has two additional command positions, namely a command position for acceleration, which lies beyond the ON position for the left turn signal in countries having right-hand traffic, and a command position for deceleration, which lies beyond the ON position for the right turn signal. In countries having left-hand traffic, this is correspondingly reversed. A changeover may occur automatically via the navigation system, for example.

The possibility of manually decelerating the vehicle in the event of a lane change to the right, i.e., to the slower lane, proves to be particularly advantageous because in such situations the radar sensor and the ACC system require a relatively long time until the slower vehicle, for example, a truck, in the right neighboring lane is detected and analyzed appropriately as a new target object. If the driver does not intervene in a timely manner, the distance to the slower vehicle often falls significantly below the safety distance. The necessity of intervening in the regulation in such situations by operating the brake pedal reduces the acceptance of the ACC system and may also result in dangerous situations if the driver notices too late that he must operate the brake pedal. In addition, the ACC system is deactivated by the operation of the brake pedal, so that the driver must reactivate the system again afterward, which is perceived as annoying.

With the approach according to the present invention, in contrast, the driver may achieve the required deceleration very easily and comfortably simply by pivoting the turn-signal switch somewhat further to the right. Significantly greater acceptance is to be expected for this approach, since the concept “driving without operating the foot pedal” is not violated and deactivation of the ACC system in connection with the brake pedal operation is also avoided.

The turn-signal switch is preferably implemented as a pushbutton in regard to the additional command positions, i.e., it automatically returns into the associated ON position as soon as the lever is released.

According to a refinement, a position transducer or a force sensor may also be assigned to the turn-signal switch in each of the command positions, so that the intensity of the acceleration and/or deceleration may be controlled via the extent of the deflection of the turn-signal lever or the intensity of the operation force as needed.

Alternatively, the acceleration may be increased/decreased via the duration of the activation (integral behavior). This is advantageous, since no additional sensors are required.

### BRIEF DESCRIPTION OF THE DRAWINGS

FIG. 1 shows a schematic sketch of a turn-signal switch according to the present invention.

FIG. 2 shows an enlarged schematic illustration of a position sensor for the turn-signal switch according to FIG. 1.

FIG. 3 shows a position sensor and force sensors for a turn-signal switch according to another specific embodiment.

### DETAILED DESCRIPTION

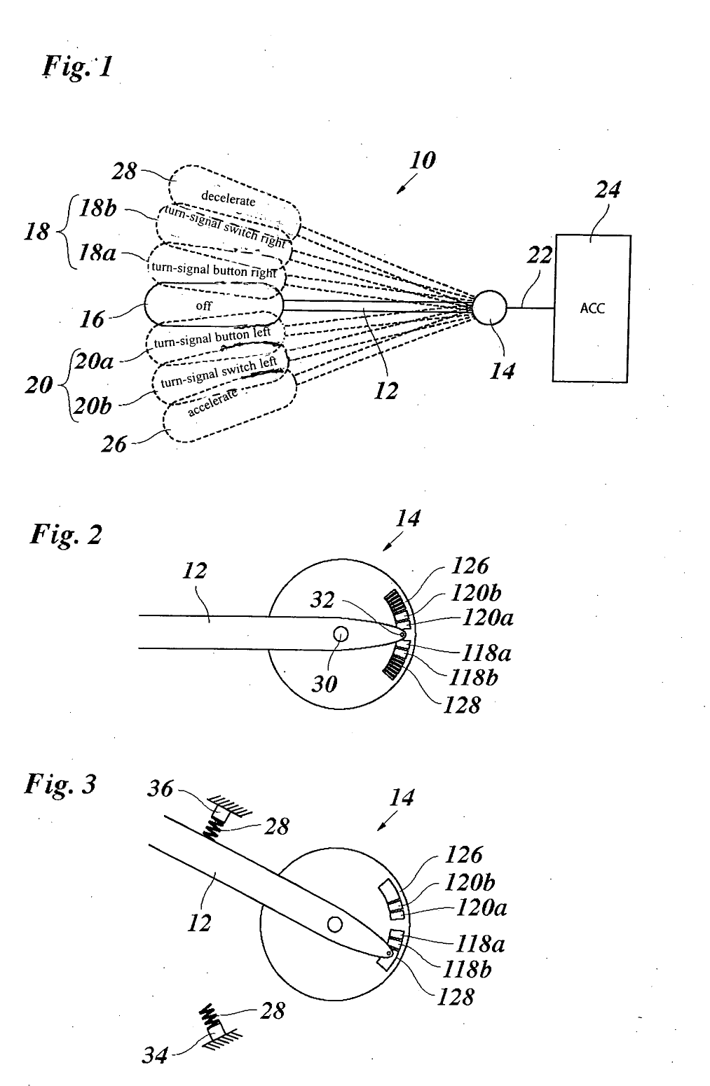

FIG. 1 schematically shows a turn-signal switch 10, which, as is typical, has a lever 12, an associated position sensor 14, and catch and restoring mechanisms, which are known in principle and are not shown here. Lever 12 is situated on a steering column (not shown) in such a way that it projects laterally from the steering column, to the left in the example shown. By pivoting lever 12 upward, i.e., in the same rotational direction as in a rotation of the steering wheel to the right, the right turn signal of the vehicle is turned on, and the left turn signal is accordingly turned on by pivoting downward.

The turn-signal switch accordingly has an OFF position 16, which is shown in FIG. 1 in solid lines, as well as two ON positions 18, 20 (shown by dashed lines) for the right and left turn signals, respectively. Each ON position is in turn subdivided into a touch stage 18a and 20a and a switched stage 18b and 20b. In the touch stage, lever 12 is elastically pre-tensioned in the direction toward OFF position 16, and the turn signal only remains turned on as long as the user holds the lever in the relevant position against the elastic restoring force. In contrast, if lever 12 is pivoted beyond the touch stage into switched stage 18b or 20b, the lever engages in the relevant position and the turn signal remains turned on until lever 12 is manually reset by the user or is automatically unlocked by a mechanism coupled to the steering wheel movement, so that it returns to the OFF position.

The positions of lever 12 are detected by position sensor 14 and converted into electronic signals, which are transmitted in a known way to the turn-signal relay of the motor vehicle. In addition, the position sensor is connected here via a multistrand cable or preferably via an integrated vehicle data bus 22 (e.g., CAN bus) to an adaptive cruise control (ACC) 24. The construction of cruise control 24 is known per se and is not described in greater detail here. Only the mode of operation is explained briefly.

When the cruise control is activated and the lane of the vehicle is free in front, the travel velocity of the vehicle is regulated by cruise control 24 to a desired velocity selected by the driver. If a slower vehicle traveling ahead is located in the occupied lane by a radar sensor (not shown), cruise control 22 intervenes in the drive system and, if necessary, also in the brake system of the vehicle in such a way that the velocity of this vehicle is comfortably adapted to the velocity of the vehicle traveling ahead, using suitably limited accelerations and decelerations, and the vehicle traveling ahead is followed at a suitable (velocity-dependent) safety distance. The signals transmitted from position sensor 14 to cruise control 24 may be used in a known way for the purpose of communicating a lane change intention of the driver to the cruise control, so that, for example, the positioning range of the radar sensor may be expanded temporarily to the neighboring lane, to which the driver intends to change.

Turn-signal switch 10 has, viewed from OFF position 16, a command position 26 beyond ON position 20 for the left turn signal, in which an acceleration command is transmitted to cruise control 24. The normal regulatory function of cruise control 24 is overridden by the acceleration command manually input in this way via turn-signal switch 10 and the vehicle is caused to accelerate, at an acceleration which exceeds the normal setpoint acceleration set in the controller. The function of turn-signal switch 10 in command position 26 is thus comparable to the function of a typical operating lever of a cruise control or ACC system, using which the vehicle may be manually caused to accelerate. However, the acceleration command input via command position 26 preferably results in a stronger acceleration of the vehicle.

Command position 26 has the following purpose above all. If the driver intends to change to the passing lane on the left to pass a slower vehicle, he will operate the left turn signal as usual. If the driver now recognizes in the rearview mirror that a faster vehicle is approaching rapidly from the rear in the passing lane, for example, he only needs to move lever 12 further downward to cause a rapid acceleration of his own vehicle and thus adapt his velocity more rapidly to that of the traffic in the passing lane.

In command position 26, lever 12 preferably operates as a pushbutton, i.e., the lever is elastically pre-tensioned in switched stage 20b, and the acceleration command is only output as long as the driver holds lever 12 in command position 26. When the driver releases lever 12, cruise control 24 returns back to the normal distance or velocity regulation, preferably using soft transitions.

Cruise control 24 may also optionally operate in such a way that, as long as the acceleration command is active, a specific positive value is added to the distance-dependent setpoint acceleration calculated in the normal regulating mode, which ensures the additional acceleration. The acceleration command is then superimposed on the normal regulatory function, with the result that in the event of an excessive approach to a vehicle traveling ahead in the passing lane, the acceleration is automatically reduced again or entirely suppressed or reversed, so that an excessively close approach to the vehicle traveling ahead is automatically prevented.

The signal output by position sensor 14 in command position 26 may also optionally cause the catch for lever 12 in switched stage 20b to be switched so it is inactive (similarly as upon a return of the steering wheel into the neutral position), so that lever 12 returns immediately to OFF position 16 when it is released in command position 26.

The movement of lever 12 from OFF position 16 into command position 26 may occur as follows, for example. When the user pivots the lever downward from OFF position 16, he first has to overcome a slight restoring force while the lever is located in the area of touch stage 20a. Upon approaching switched stage 20b, the lever automatically engages and moves slightly away from the finger of the user, so that the user no longer needs to apply a force to bring the lever entirely into switched stage 20b. Therefore, there is practically no danger that the user will unintentionally bring the lever into command position 26 when he merely wishes to operate the turn signal to indicate his intention of making a turn, for example. The acceleration of the vehicle is only triggered when the user pivots the lever downward actively beyond switched stage 20b and overcomes the catch resistance active in the switched stage.

In the example shown, turn-signal switch 10 has a further command position 28 beyond switched stage 18b for the right turn signal, in which a deceleration command is output to cruise control 24. This function offers the driver the comfortable option of reducing the velocity as a precaution in the event of a lane change to the slower right lane, so that a velocity may be adapted even before the distance regulation is active on the right lane. The deceleration of the vehicle may be performed by intervening in the drive system and also by intervening in the brake system depending on the amount of the deceleration required by the deceleration command.

It is important that the driver may actively brake the vehicle with the aid of command position 28 without operating the brake pedal. In addition to increasing the comfort, this has the advantage above all that the function of cruise control 24 remains active, while the cruise control would be turned off (as is generally typical) upon operation of the brake pedal and would then have to be cumbersomely activated by hand again.

The statements made above for command position 26 apply analogously for the movement of lever 12 from OFF position 16 into command position 28 and for the return into the OFF position.

In the specific embodiment described above, the signal output in command position 26 or 28 is simply a logical signal which causes a positive or negative, possibly velocity-dependent setpoint acceleration to be set in cruise control 24 or a corresponding acceleration value to be added to the setpoint acceleration calculated in the framework of the normal distance regulation.

FIG. 2 shows a specific embodiment of position sensor 14 which also allows the driver to determine the intensity of the acceleration and/or deceleration with the aid of lever 12 in command position 26 or 28. The illustration in FIG. 2 is strongly schematic and is solely to illustrate the principle. Lever 12 is mounted in position sensor 14 in such a way that it is pivotable around an axis 30 and has a sliding contact 32 in a projecting end section. This sliding contact 32 cooperates with countercontacts 118a, 118b, 120a, 120b, 126, and 128, which are situated on a circular arc around axis 30. Countercontacts 118a and 120a correspond to touch stages 18a and 20a, while countercontacts 118b and 120b correspond to switched stages 18b and 20b. Countercontacts 126 correspond to command position 26 and form a group of multiple contact fields, which are used to generate a multivalue signal, which indicates the angle of lever 12 in command position 26 like a position transducer. In this way, the driver may determine the intensity of the desired acceleration by pivoting lever 12 different distances downward against the force of a restoring spring (not shown) in the area of command position 26. Similarly, countercontacts 128 form a position transducer, using which the intensity of the deceleration command in command position 28 may be selected.

FIG. 3 illustrates a modified exemplary embodiment, in which a multivalue acceleration or deceleration command may also be input. Countercontacts 126 and 128 do generate only a logical signal which indicates that lever 12 is located in command position 26 or 28, but the force with which the driver presses lever 12 downward into command position 26 or upward into command position 28 is additionally measured here using force sensors 34, 36. The lever is pressed by the driver against a schematically illustrated restoring spring 38, which is supported via the relevant force sensor on a fixed buttress.

1-7. (canceled)

8. A turn-signal switch for a motor vehicle, which has an adaptive cruise control, comprising:
an OFF position;
an ON position; and
at least one command position situated beyond the ON position for outputting a command to the cruise control to modify a setpoint acceleration.

9. The turn-signal switch according to claim 8, further comprising a first command position beyond a first ON position to output an acceleration command and a second command position beyond a second ON position to output a deceleration command.

10. The turn-signal switch according to claim 8, wherein the switch operates as a pushbutton in the command position.

11. The turn-signal switch according to claim 8, wherein the switch outputs a multivalue command signal whose value indicates an intensity of a modification of the setpoint acceleration.

12. The turn-signal switch according to claim 11, further comprising an integrated position transducer for generating the multivalue command signal.

13. The turn-signal switch according to claim 11, further comprising an integrated force sensor for generating the multivalue command signal.

14. The turn-signal switch according to claim 11, further comprising a device for generating the multivalue command signal as a function of a duration of a pushbutton operation.
